(19) United States
(12) Patent Application Publication
(10) Pub. No.: US 2010/0285867 A1
(43) Pub. Date: Nov. 11, 2010

(54) GAMING MACHINE AND ITS PLAYING METHOD

(75) Inventor: Kazuo Okada, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ARUZE GAMING AMERICA, INC., LAS VEGAS, NV (US)

(21) Appl. No.: 12/067,371

(22) PCT Filed: Jan. 26, 2007
(86) PCT No.: PCT/JP07/51312

§ 371 Date: Mar. 19, 2008

(51) Int. Cl. A63F 9/24; A63F 13/00

(52) U.S. Cl. 463/25; 463/30

(57) ABSTRACT

A game controller 100 for providing a predetermined amount of credits for each award to a player when a game is started after the player inputs a bet and a game result which provides an award to the player occurs, and a display device for displaying the game result to the player are provided. Furthermore, the game controller 100 is configured to perform processing for: determining whether to store a predetermined amount of credits in credit retaining memory installed inside or outside the game controller in a unit game where processing for determining whether to provide the award to the player is performed and, in a case of determining to store the predetermined amount of credits, storing the amount of credits which cumulatively adds the amount of credits thus determined to the amount of credits stored in the credit retaining memory; determining whether or not to provide a portion of the total amount of credits stored in the credit retaining memory to the player in a unit game where processing for determining whether to provide the award to the player is performed; and, in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

### TECHNICAL FIELD

The present invention relates to a gaming machine and a method of play thereof.

### BACKGROUND ART

Conventionally, a gaming machine has been known which employs a method of storing a portion of credits bet so as to pay out all the accumulated credits upon winning a jackpot lottery, or a method of paying out various amounts of credits in multiple steps. It has been proposed that such a progressive bonus called jackpot is applied to various gaming machines.

Patent document 1: U.S. Unexamined Patent Application, First Publication No. 2003/0069073

Patent document 2: U.S. Unexamined Patent Application, First Publication No. 2003/0073486

Patent document 3: U.S. Unexamined Patent Application, First Publication No. 2003/0073487

Patent document 4: U.S. Unexamined Patent Application, First Publication No. 2003/0078095

Patent document 5: U.S. Unexamined Patent Application, First Publication No. 2003/0064810

Patent document 6: U.S. Unexamined Patent Application, First Publication No. 2003/0064809

Patent document 7: U.S. Unexamined Patent Application, First Publication No. 2003/0069067

### DISCLOSURE OF THE INVENTION

### Problems to be Solved by the Invention

The present invention devises timings such as to accumulate credits, to pay out the credits thus accumulated, and the like on a gaming machine, thereby providing a gaming machine and a method of play thereof with entertainment properties which the foregoing prior arts do not have.

### Means for Solving the Problems

More specifically, the following is provided.

In a first aspect of the present invention, a gaming machine includes:

a game controller for providing a predetermined amount of credits to a player for each award in a case where a game is started after the player inputs a bet and a game result which provides an award to the player occurs; and

a display device for displaying the game result to the player,

in which the game controller is configured to perform processing for:

(a) determining whether to store a predetermined amount of credits in credit retaining memory installed either inside or outside the game controller in a unit game where processing for determining whether to provide the award to the player is performed, and, in a case of determining to store the predetermined amount of credits, storing the amount of credits is the amount of credits thus determined cumulatively added to the amount of credits stored in the credit retaining memory;

(b) determining whether to provide a portion of the total amount of credits stored in the credit retaining memory to the player in a unit game where processing for determining whether to provide the award to the player is performed; and

(c) in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

According to the first aspect of the present invention, the gaming machine is configured to perform the following processing for: (a) determining whether to store a predetermined amount of credits in credit retaining memory installed in one of inside or outside the game controller in a unit game where processing for determining whether to provide the award to the player is performed, and, in a case of determining to store the predetermined amount of credits, storing the amount of credits, which is the amount of credits thus determined cumulatively added to the amount of credits stored, in the credit retaining memory; (b) determining whether to provide a portion of the total amount of credits stored in the credit retaining memory to the player in a unit game where processing for determining whether to provide the award to the player is performed; and (c) in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

Therefore, the gaming machine determines whether to store the amount of credits which is cumulatively added to the predetermined amount of credits in the credit retaining memory in a unit game, and determines whether to provide a portion of the total amount of credits stored in the credit retaining memory to the player in the unit game. In a case of determining to provide a portion of the total amount of credits stored in the credit retaining memory to the player, the gaming machine can provide a portion of the total amount of credits to the player, thereby providing a novel game that makes the player keep continuing the game.

In a second aspect of a gaming machine according to the first aspect, the determination in processing (a) is determined based on a numeric value determined by random numbers.

According to the second aspect of the present invention, the gaming machine determines the processing (a) based on a numeric value determined by random numbers.

Therefore, the gaming machine determines whether to store the amount of credits which is the predetermined amount of credits cumulatively added in the credit retaining memory in a unit game, and determines whether to provide a portion of the total amount of credits stored in the credit retaining memory to the player in the unit game. In a case of determining to provide a portion of the total amount of credits stored in the credit retaining memory to the player, it can be determined by random numbers. Therefore, in a case of providing a portion of the total amount of credits to the player, the gaming machine can add contingency to the game, thereby providing to the player a novel game.

In a third aspect of the gaming machine according to the first aspect, a portion of the amount of credits among the total amount of credits provided to the player is determined based on a numeric value determined by random numbers in the processing (c).

According to the third aspect of the present invention, the gaming machine determines the amount of a portion of the amount of credits among the total amount of credits provided to a player based on a numeric value determined by random numbers in the processing (c).

Therefore, in a case of determining a predetermined amount of credits provided to a player, it can be determined by random numbers. Therefore, in a case of determining the amount of a portion of the total amount of credits provided to the player, the gaming machine can add contingency to the game, thereby providing the player a novel game.

In a fourth aspect of the gaming machine according to the first aspect, sound data corresponding to the amount of credits provided to the player is output when the portion of the total amount of credits is provided to the player in the processing (c).

According to the fourth aspect of the present invention, in a case of storing the amount of credits which is the amount of credits stored cumulatively added in the credit retaining memory, sound data corresponding to the amount of credits provided to the player is output when the portion of the total amount of credits is provided to the player.

Therefore, the gaming machine can inform the player by way of a sound corresponding to the amount of credits that a portion of the total amount of credits is provided to the player. Consequently, the player can recognize the amount of credits thus provided based on the sound alone.

In a fifth aspect of the gaming machine according to the first aspect, determining whether to store the amount of credits to which the amount of credits stored in the credit retaining memory is cumulatively added is based on the number of games executed.

According to the fifth aspect of the present invention, determining whether to store the amount of credits to which the amount of credits stored in the credit retaining memory is cumulatively added is based on the number of games executed.

Therefore, the gaming machine cumulatively adds the credits in the credit retaining memory based on the number of games executed, enabling the credit to be added routinely, and thereby providing to the player a novel game to allow the player to keep continuing the game.

In a sixth aspect of the gaming machine according to the first aspect, whether to store the amount of credits to which the amount of credits stored in the credit retaining memory is cumulatively added is determined based on whether a predetermined amount of time has elapsed.

According to the sixth aspect of the present invention, whether to store the amount of credits to which the amount of credits stored in the credit retaining memory is cumulatively added is determined based on whether a predetermined amount of time has elapsed.

Therefore, the gaming machine cumulatively adds the credit in the credit retaining memory based on whether a predetermined amount of time has elapsed, enabling the credit to be added routinely, thereby providing a novel game that makes the player keep continuing the game.

In a seventh aspect of the gaming machine according to the first aspect, in a case of determining whether to provide a portion of the total amount of credits to the player, image data corresponding to the amount of credits provided to the player is output when the portion of the total amount of credits is provided to the player.

According to the seventh aspect of the present invention, in a case of determining whether to provide a portion of the total amount of credits to the player, image data corresponding to the amount of credits provided to the player is output when the portion of the total amount of credits is provided to the player.

Therefore, the gaming machine can informs the player by way of image data corresponding to the amount of credits that a portion of the total amount of credits is provided to the player. Consequently, the player can visually recognize the amount of credits thus provided.

In an eighth aspect of the gaming machine according to the first aspect, the game which the gaming controller executes is a slot machine game, and the unit game refers to a game with one unit during which the player bets a credit, so that a reel is rotated and then stopped.

According to the eighth aspect of the present invention, a game which the gaming controller executes is a slot machine game, and the unit game refers to a game with one unit during which the player bets a credit, so that a reel is rotated and then stopped.

Therefore, the gaming machine performs the unit game which refers to a game with one unit during which a reel is rotated and then stopped, and can perform storing in a credit retaining memory and the like.

In a ninth aspect, a gaming machine includes: a game controller for providing a predetermined amount of credits to a player for each award in a case where a game is started after the player inputs a bet and a game result which provides an award to the player occurs; and

a display device for displaying the game result to the player,

in which the game controller is configured to perform the following processing for:

(a) determining whether or not to store a predetermined amount of credits, which is different from the credit that the player input the bet, in a credit retaining memory installed either inside or outside the game controller in a unit game where processing for determining whether to provide the award to the player is performed, and, in a case of determining to store the predetermined amount of credits, storing the amount of credits which is the amount of credits thus determined cumulatively added to the amount of credits stored in the credit retaining memory;

(b) determining whether to provide a portion of the total amount of credits stored in the credit retaining memory to the player in a unit game where processing for determining whether to provide the award to the player is performed; and

(c) in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

According to the ninth aspect of the present invention, the gaming machine is configured to perform the following processing for: (a) determining whether to store a predetermined amount of credits, which is different from the credit that the player input as the bet, in credit retaining memory installed either inside or outside the game controller in a unit game where processing for determining whether to provide the award to the player is performed, and, in a case of determining to store the predetermined amount of credits, storing the amount of credits which is the amount of credits thus determined cumulatively added to the amount of credits stored in the credit retaining memory; (b) determining whether to provide a portion of the total amount of credits stored in the credit retaining memory to the player in a unit game where processing for determining whether to provide the award to the player is performed; and (c) in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

Therefore, the gaming machine determines whether to store the amount of credits which is the predetermined amount of credits cumulatively added in the credit retaining memory in a unit game, and determines whether to provide a portion of the total amount of credits stored in the credit retaining memory to the player in the unit game. In a case of determining to provide a portion of the total amount of credits stored in the credit retaining memory to the player, the gaming machine can provide a portion of the total amount of credits to the player, thereby providing a novel game that makes the player keep continuing the game. Moreover, a credit stored in a credit retaining memory is different from a credit that a player input as the bet, thereby providing a novel game that makes the player keep continuing the game.

In a tenth aspect of the present invention, a method of playing a game includes:

(a) starting a game after a player inputs a bet;

(b) providing a predetermined amount of credits to the player for each award in a case where a game result which provides an award to the player occurs;

(c) displaying the game result to the player;

(d) determining whether to store a predetermined amount of credits in memory in a unit game where processing for determining whether to provide the award to the player is performed, and, in a case of determining to store the predetermined amount of credits, storing the amount of credits which is the amount of credits thus determined cumulatively added to the amount of credits stored in the memory;

(e) determining whether to provide a portion of the total amount of credits stored in the memory to the player in a unit game where processing for determining whether to provide the award to the player is performed; and

(f) in a case of determining to provide a portion of the total amount of credits stored in the memory to the player, providing a portion of the total amount of credits stored in the credit retaining memory to the player and subtracting the amount of credits thus provided to the player from the amount of the total amount of credits stored in the memory.

According to the tenth aspect of the present invention, a method of playing a game includes: (a) starting a game after a player inputs a bet; (b) providing a predetermined amount of credits for each award to the player in a case where a game result which provides an award to the player occurs; (c) displaying the game result to the player; (d) determining whether or not to store a predetermined amount of credits in memory installed either inside or outside the game controller in a unit game where processing for determining whether to provide the award to the player is performed, and, in a case of determining to store the predetermined amount of credits, storing the amount of credits which is the amount of credits thus determined cumulatively added to the amount of credits stored in the memory; (e) determining whether to provide a portion of the total amount of credits stored in the memory to the player in a unit game where processing for determining whether to provide the award to the player is performed; and (f) in a case of determining to provide a portion of the total amount of credits stored in the memory to the player, providing a portion of the total amount of credits stored in the credit retaining memory to the player and subtracting the amount of credits thus provided to the player from the amount of the total amount of credits stored in the memory.

Therefore, the method of playing a game determines whether to store the amount of credits which is the predetermined amount of credits cumulatively added in a memory in a unit game, and determines whether to provide to the player a portion of the total amount of credits stored in the credit retaining memory in the unit game. In a case of determining to provide a portion of the total amount of credits stored in the memory to the player, the method of playing a game can provide a portion of the total amount of credits to the player, thereby providing a novel game that makes the player keep continuing the game.

In an eleventh aspect, according to the method of playing a game according to the tenth aspect, the determination in the processing (a) is determined based on a numeric value determined by random numbers.

According to the eleventh aspect of the present invention, the processing (a) is determined based on a numeric value determined by random numbers.

Therefore, the method of playing a game determines whether to store the amount of credits which is the predetermined amount of credits cumulatively added in the credit retaining memory in a unit game, and determines whether to provide a portion of the total amount of credits stored in the credit retaining memory to the player in the unit game. In a case of determining to provide a portion of the total amount of credits stored in the credit retaining memory to the player, it can be determined by random numbers. Therefore, in a case of providing a portion of the total amount of credits to the player, the gaming machine can add contingency to the game, thereby providing the player a novel game.

In a twelfth aspect, according to the method of playing a game according to tenth aspect, a portion of the amount of credits among the total amount of credits provided to the player is determined based on a numeric value determined by random numbers in the processing (c).

According to the twelfth aspect of the present invention, the method of playing a game determines the amount of a portion of the amount of credits among the total amount of credits provided to a player based on a numeric value determined by random numbers in the processing (c).

Therefore, in a case of determining a predetermined amount of credits provided to a player, it can be determined by random numbers. Therefore, in a case of determining the amount of a portion of the total amount of credits provided to the player, the method of playing a game can add contingency to the game, thereby providing to the player a novel game.

In a thirteenth aspect, according to the method of playing a game according to the tenth aspect, sound data corresponding to the amount of credits provided to the player is output when the portion of the total amount of credits is provided to the player in the processing (c).

According to the thirteenth aspect of the present invention, in a case of storing the amount of credits which is the amount of credits cumulatively added stored in the credit retaining memory, sound data corresponding to the amount of credits provided to the player is output when the portion of the total amount of credits is provided to the player.

Therefore, the method of playing a game can inform the player by way of a sound corresponding to the amount of credits that a portion of the total amount of credits is provided to the player. Consequently, the player can recognize the amount of credits thus provided based on the sound alone.

In a fourteenth aspect, according to the method of playing a game according to the tenth aspect, determining whether to store the amount of credits to which the amount of credits stored in the memory is cumulatively added is based on the number of games executed.

According to the fourteenth aspect of the present invention, determining whether to store the amount of credits to which the amount of credits stored in the memory is cumulatively added is based on the number of games executed.

Therefore, the method of playing a game cumulatively adds the credit in the memory based on the number of games executed, enabling the credit to be added routinely, thereby providing to the player a novel game to allow the player to keep continuing the game.

In a fifteenth aspect, according to the method of playing a game according to tenth aspect, determining whether to store the amount of credits to which the amount of credits stored in the memory is cumulatively added is based on whether a predetermined amount of time has elapsed.

According to the fifteenth aspect of the present invention, determining whether to store the amount of credits to which the amount of credits stored in the memory is cumulatively added is determined based on whether a predetermined amount of time has elapsed.

Therefore, the method of playing a game cumulatively adds the credit in the memory based on whether a predetermined amount of time has elapsed, enabling the credit to be added routinely, thereby providing a novel game that makes the player keep continuing the game.

In a sixteenth aspect, according to the method of playing a game according to tenth aspect, in a case of determining whether to provide a portion of the total amount of credits to the player, an image corresponding to the amount of credits provided to the player is output when the portion of the total amount of credits is provided to the player.

According to the sixteenth aspect of the present invention, in a case of determining whether to provide a portion of the total amount of credits to the player, image data corresponding to the amount of credits provided to the player is output when the portion of the total amount of credits is provided to the player.

Therefore, the method of playing a game can inform the player by way of an image corresponding to the amount of credits that a portion of the total amount of credits is provided to the player. Consequently, the player can visually recognize the amount of credits thus provided.

### Effects of the Invention

According to the present invention, timings are devised such as to accumulate credits, to pay out the credits thus accumulated, and the like on a gaming machine, thereby enabling provision of a gaming machine and a method of play thereof with entertainment properties which the foregoing prior arts do not have.

### BRIEF DESCRIPTION OF THE DRAWINGS

FIG. 1 is a perspective diagram showing a gaming machine according to the embodiment of the present invention;

FIG. 2 is a diagram showing an enlarged view of the display region of the gaming machine according to the embodiment of the present invention;

FIG. 3 is a block diagram showing an electrical configuration of a controller of a gaming machine according to the embodiment of the present invention;

FIG. 4 is a block diagram showing an electrical configuration of a display/input controller of a gaming machine according to the embodiment of the present invention;

FIG. 5 is a block diagram showing an electrical configuration of a central controller according to the embodiment of the present invention;

FIG. 6 is a diagram showing a symbol line represented on each video reel according to the embodiment of the present invention;

FIG. 7 is a diagram showing a symbol arrangement table according to the embodiment of the present invention;

FIG. 8 is a flowchart showing a processing flow in the slot game according to the embodiment of the present invention;

FIG. 9 is a flowchart showing a processing flow in the stock processing according to the embodiment of the present invention;

FIG. 10 is a flowchart showing a flow of stock generation processing 1 according to the embodiment of the present invention;

FIG. 11 is a flowchart showing a flow of processing stock generation 2 according to the embodiment of the present invention;

FIG. 12 is a flowchart showing a flow of processing stock generation 3 according to the embodiment of the present invention;

FIG. 13 is a flowchart showing a flow of stock payout processing according to the embodiment of the present invention;

FIG. 14 is a diagram showing a first random number table according to embodiment of the present invention;

FIG. 15 is a diagram showing a second random number table according to the embodiment of the present invention;

FIG. 16 is a diagram showing a third random number table according to the embodiment of the present invention;

FIGS. 17A and 173 are diagrams showing a fourth random number table according to the embodiment of the present invention;

FIGS. 18 to 21 are diagrams showing examples of images displayed according to the embodiment of the present invention; and

FIG. 22 is a diagram showing a schematic configuration of the gaming system according to the embodiment of the present invention.

### PREFERRED MODE FOR CARRYING OUT THE INVENTION

Description is made regarding an embodiment of the present invention with reference to the drawings.

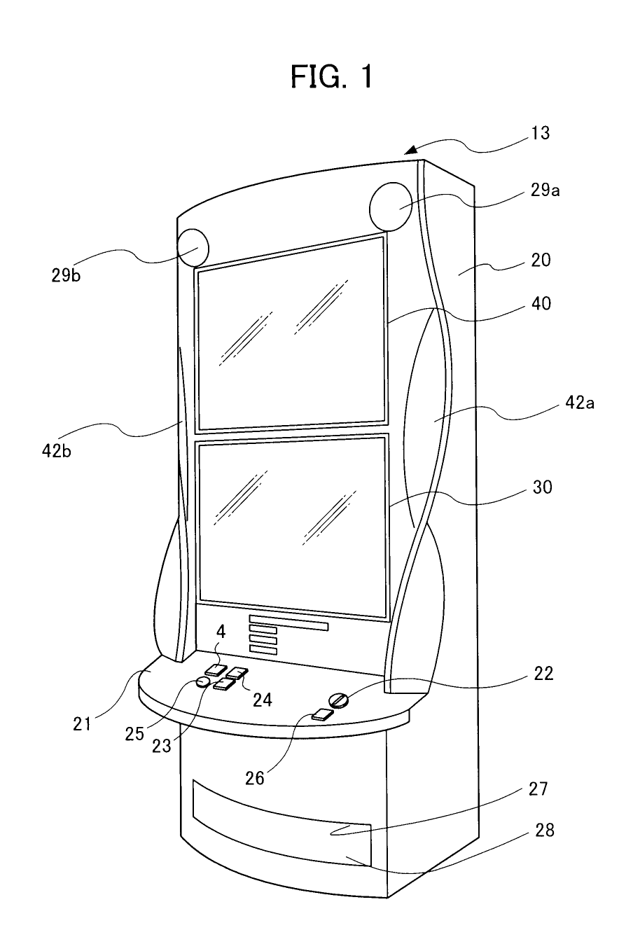

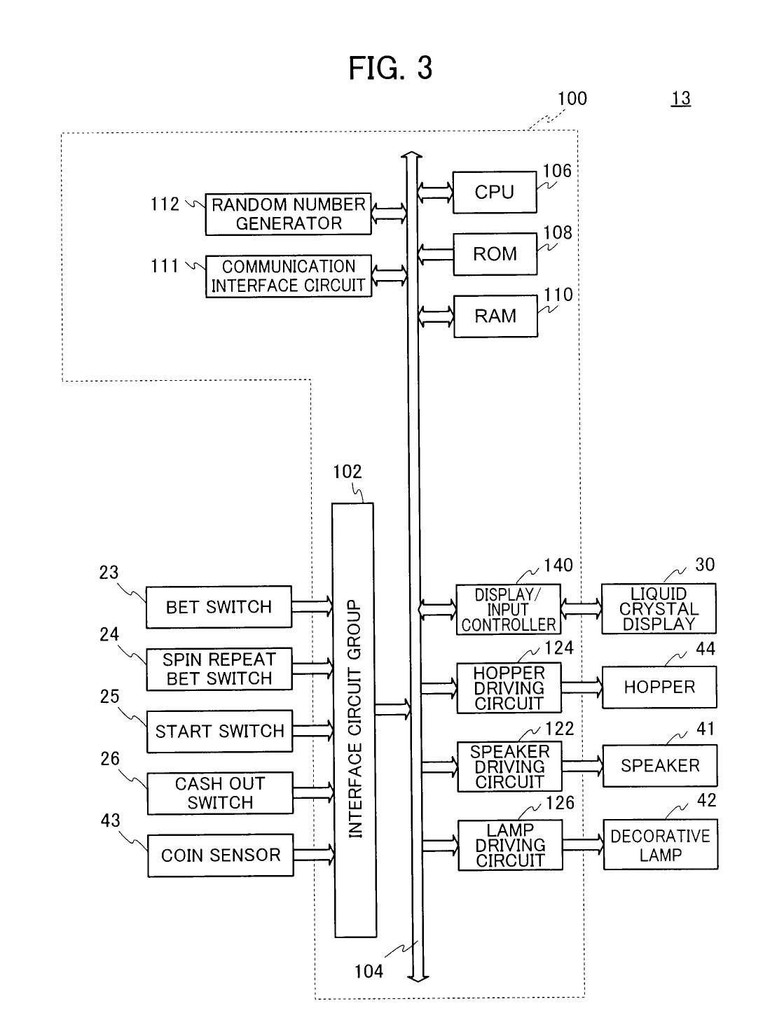

FIG. 1 is a perspective diagram showing a gaming machine 13 according to an embodiment of the present invention. The gaming machine 13 includes a cabinet 20. The cabinet 20 has a structure in which the face facing the player is open. The cabinet 20 includes various types of components. Such components include: a game controller 100 (see FIG. 3) for electrically controlling the gaming machine 13; a hopper 44 (FIG. 3) for controlling the insertion of coins (gaming medium) and for retaining and paying out the coins; etc. The gaming medium is not restricted to coins. The game medium is not restricted to coins. In addition, examples of such game media include medals, tokens, electronic money, or electronic value information (credit) having the same value.

The liquid crystal display 30 is installed substantially in the middle of the front face of the cabinet 20, and the liquid crystal display 40 is installed in upper side of the cabinet 20.

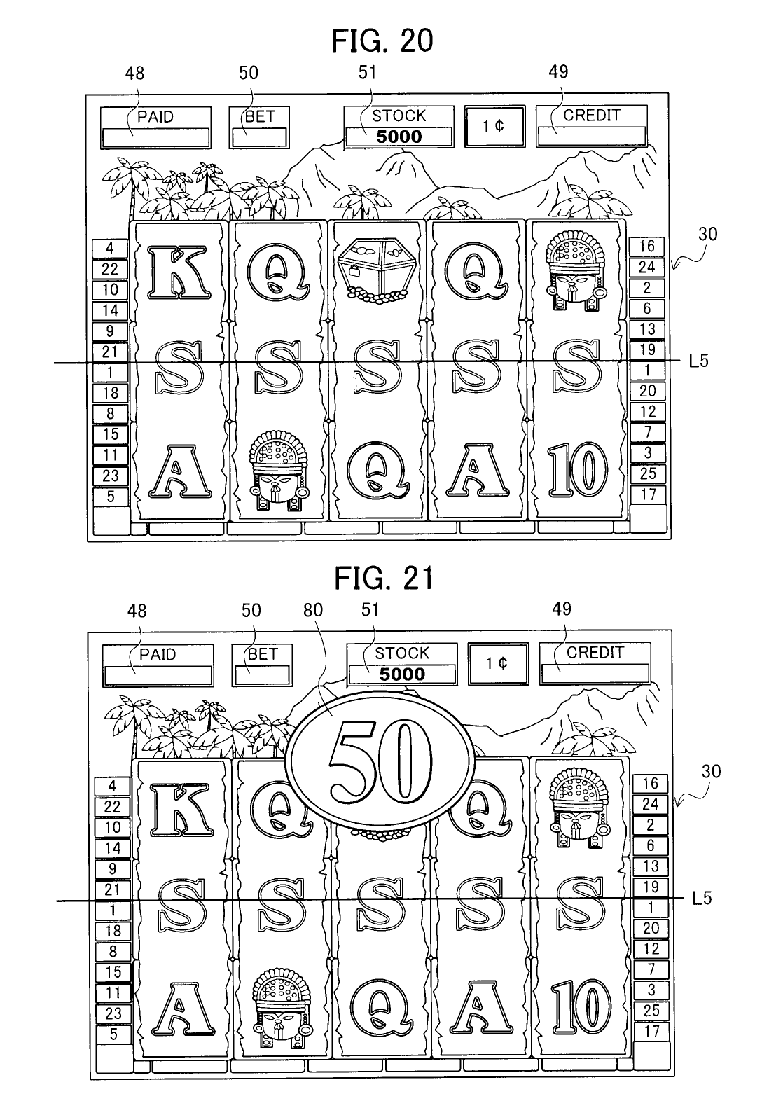

The liquid crystal display 30 is provided as a display device for displaying various types of images with respect to the game such as images for providing visual effects. Such a configuration allows the player to advance the game while visually confirming various types of images displayed on the liquid crystal display 30. In such a game, the liquid crystal display 30 displays images for the slot game as shown in FIGS. 18 through 21.

The gaming machine 13 includes video reels. With such an arrangement, five virtual reels are displayed on the liquid crystal display 30. It should be noted that the term “video reel” as used here represents a mechanism for displaying a reel on the liquid crystal display 30 in the form of an image instead of mechanical reel. Note that the term “video reel” as used here represents a mechanism for displaying a reel on the liquid crystal display 30 in the form of an image, instead of a mechanical reel. Multiple types of symbols necessary for the basic game include “BONUS”, “WILD”, “TREASURE BOX”, “GOLDEN MASK”, “HOLY GRAIL”, “COMPASS & MAP”, “SNAKE”, “A”, “K”, “Q”, “J”, and “10”.

With such an arrangement, the liquid crystal display 30 displays these symbols with an image as if the reel has rotated. The other liquid crystal display 40 provided above the liquid crystal display 30 is provided for displaying sub-images. Examples of such sub-images include an image for describing the game rules, a demonstration image, etc.

Furthermore, sound transmission openings 29a and 29b are provided to both upper left and right sides of the liquid crystal display 40. Here, the sound transmission openings 29 are provided for transmitting sound effects generated by a speaker 41 (see FIG. 3) stored within the cabinet 20. The sound transmission openings 29a and 29b generate sound effects and the like in accordance with the progress of the game. Furthermore, decorative lamps 42a and 42b are provided on both the left and right sides of approximately the middle part of the gaming machine 13. The decorative lamps 42a and 42b emit light in accordance with the progress of the game.

The slot machine 13 includes a substantially horizontal operation unit 21 below the liquid crystal display 30. Furthermore, a coin insertion opening 22, which allows the player to insert coins, is provided on the right side of the operation unit 21. On the other hand, the components provided to the left side of the operation unit 21 include: a bet switch 23 that allows the player to determine which lines are to be set to active pay lines among the nine lines L1, L2, L3, L4, L5, L6, L7, L8, and L9, for providing an award described later (which will simply be referred to as “active pay lines” hereafter), and which allows the player to select the amount of coins as game media to be bet on the active pay lines; and a spin repeat bet switch 24 that allows the player to play the game again without changing the amount of coins bet on the active pay lines from that in the immediately prior game. Such an arrangement allows the player to set the amount of coins bet on the active pay line by performing a pushing operation on either the bet switch 23 or the spin repeat bet switch 24.

With the operation unit 21, a start switch 25 is provided on the left side of the bet switch 23, which allows the player to input a start operation instruction for the basic game in increments of games. Upon performing a pushing operation on either the start switch 25 or the spin repeat bet switch 24, which serves as a trigger to start the game, the image that the five mechanical reels 3A to 3E start to rotate is displayed.

A cash out switch 26 is provided near the coin insertion opening 22 on the operation unit 21. Upon the player pushing the cash out switch 26, the inserted coins are paid out from a coin payout opening 27 provided at a lower portion of the front face. The coins thus paid out are retained in a coin tray 28.

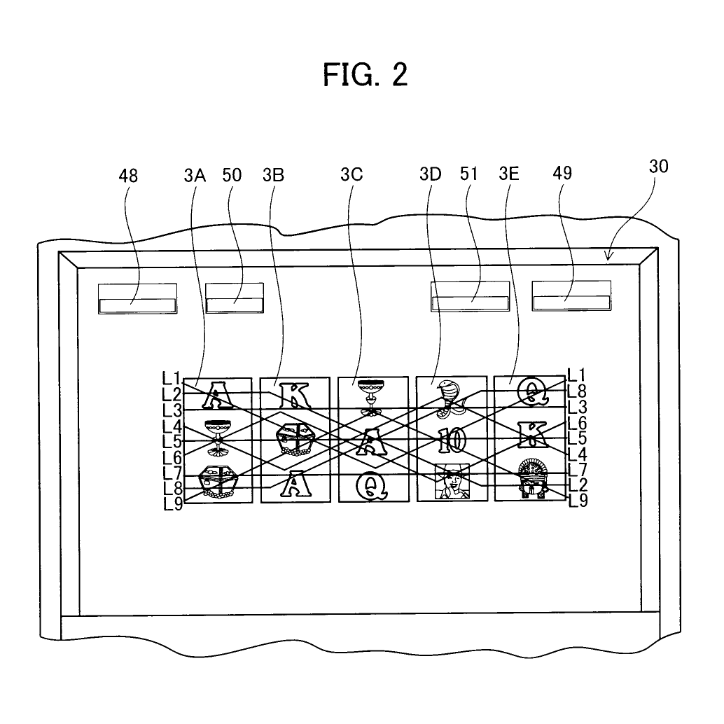

FIG. 2 is an enlarged view which shows the display region of the gaming machine 13. The gaming machine 13 has the nine lines L1 through L9 for providing nine types of awards as shown in FIG. 2. Each of the lines L1 through L9 for providing awards is formed such that it extends so as to pass through one of the symbols for each of the video reels 3A to 3E when the five video reels have stopped.

Upon pushing the bet switch 23 once, the line L3 for providing a third award, the line L5 for providing a fifth award, and the line L7 for providing a seventh award, are set to be active pay lines, and one coin is input as a credit medal, for example.

Furthermore, upon pushing the bet switch 23 twice, the line L1 for providing a first award, the line L4 for providing a fourth award, and the line L8 for providing an eighth award, are set to be active pay lines, in addition to the three lines, and two coins are input as credit medals, for example.

Moreover, upon pushing the bet switch 23 three times, the line L2 for providing a second award, the line L6 for providing a sixth award, and the line L9 for providing a ninth award, are set to be active pay lines, in addition to the six lines, and three coins are input as credit medals, for example.

The game available in the present embodiment is a game in which a predetermined set of symbols are made along the active pay lines.

Furthermore, various types of display units, i.e., a payout display unit 48, a bet amount display unit 50, a stock credit amount display unit 51, and a credit amount display unit 49, are configured to be displayed, on the upper side of the liquid crystal display 30, in order from the left. As discussed below, the stock credit amount display unit 51 may or may not be provided. The payout display unit 48 is a component for displaying the amount of the coins paid out when a specified combination of the symbols has been displayed along any one the active pay lines for providing an award. The credit amount display unit 49 is a component for displaying the amount of coins retained in the gaming machine 13 in the form of a credit. The bet amount display unit 50 is a component for displaying the bet amount, which is the amount of coins bet on the active pay lines.

FIG. 3 is a block diagram which shows an electrical configuration of the game controller 100 of the gaming machine 13. As shown in FIG. 3, the game controller 100 of the gaming machine 13 is a micro computer, and includes an interface circuit group 102, an input/output bus 104, a CPU 106, ROM 108, RAM 110, a communication interface circuit 111, a random number generator 112, a speaker driving circuit 122, a hopper driving circuit 124, a lamp driving circuit 126, and a display/input controller 140.

The interface circuit group 102 is electrically connected with the input/output bus 104, which carries out the input and output of data signals or address signals for the CPU 106.

The start switch 25 is electrically connected with the interface circuit group 102. In the interface circuit group 102, a start signal generated by the start switch 25 is converted into a predetermined form of signal to be supplied to the input/output bus 104.

Furthermore, the bet switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuit group 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

The ROM 108 and the RAM 110 are connected to the input/output bus 104. Upon receipt of the game start operation instruction input through the start switch 25, the CPU 106 reads a game program, and executes the game. The game program has been programmed so as to instruct the CPU 106 to perform the following operation. That is to say, according to the game program, the CPU 106, via the display/input controller 140, displays on the liquid crystal display 30 an image of the five video reels commencing to scroll the symbols that are disposed on the five video reels. Then, the CPU 106 displays an image of the five video reels stopping such that the combination of the symbols on these five video reels is rearranged, whereupon a new combination of the symbols is made along the active pay lines. In a case that a specified winning combination of the stationary symbols has been made along any one of the active pay lines, the CPU 106 pays out a predetermined amount of coins corresponding to the specified winning combination.

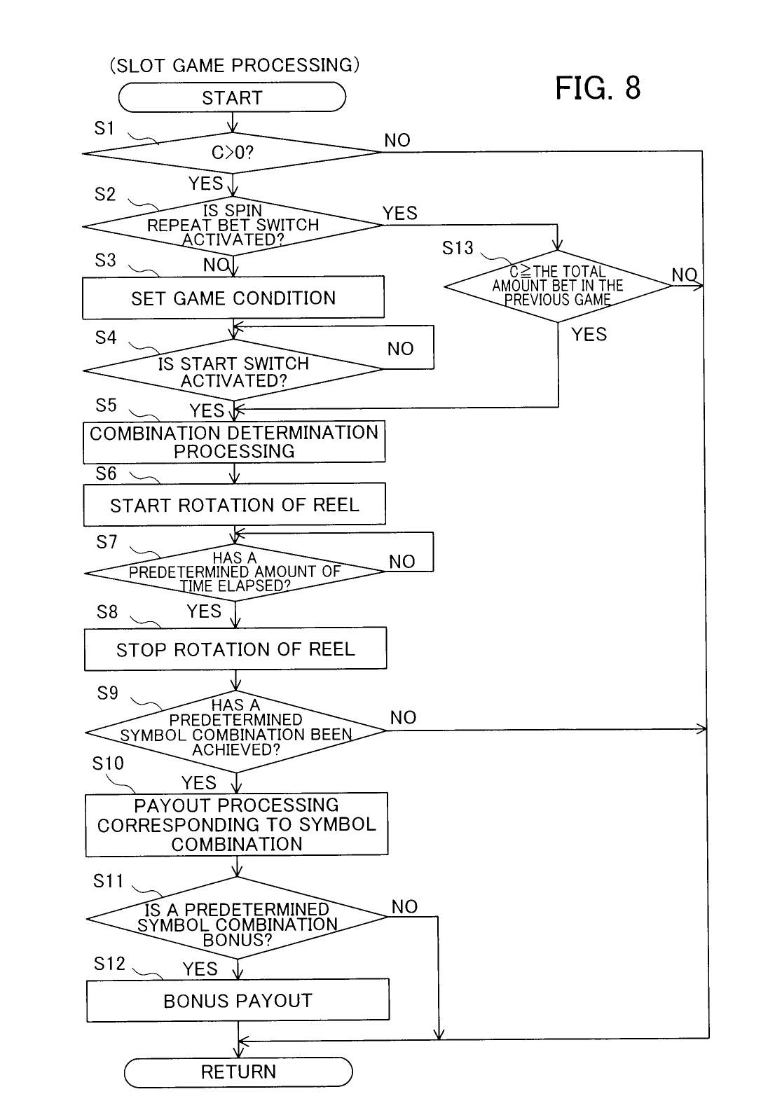

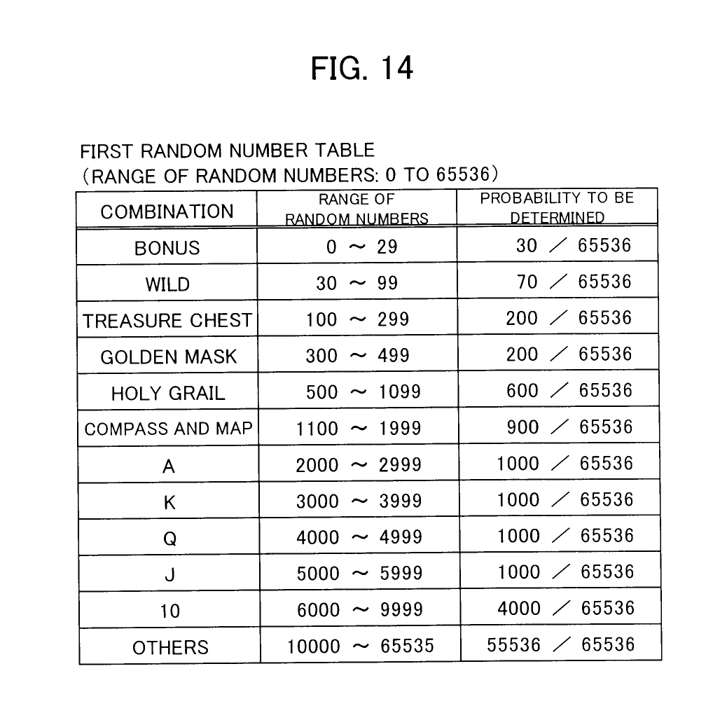

The ROM 108 stores: a control program for central control of the gaming machine 13; a program for executing routines shown in FIG. 8 through FIG. 13 (which is referred to as the “routine execution program” hereafter); initial data for executing the control program; and various data tables used for determination processing. Note that the routine execution program includes the aforementioned game program etc. On the other hand, examples of the data tables include tables such as those shown in FIGS. 14 through 17. The RAM 110 temporarily stores flags, variables, etc. used for the control program.

Furthermore, a communication interface circuit 111 is connected to the input/output bus 104. The communication interface circuit 111 is a circuit for communicating with the central controller 11 etc., via the network 12 including various types of networks such as a LAN.

The random number generator 112 for generating a random number is connected to the input/output bus 104. The random number generator 112 generates random numbers in a predetermined range of “0” to “65535” (two to the sixteenth power minus one), for example. Alternatively, an arrangement may be made in which the CPU 106 generates a random number by computation processing.

The speaker drive circuit 122 for the speakers 41 is also electrically connected with the input/output bus 104. The CPU 106 reads the sound data stored in the ROM 108, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon reception of a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

Furthermore, instead of the payment of real coins, an arrangement may be made in which the credit data is stored in a data card or the like in the coin payment step. That is to say, with such an arrangement, the player has his/her own card which serves as a storage medium. Upon the player inserting this card into the gaming machine 13, the data with respect to the credit is stored in the card.

The lamp drive circuit 126 for driving the decorative lamps 42a and 42b is also connected with the input/output bus 104. The CPU 106 transmits the signal for driving the lamps according to the predetermined conditions based on the program stored in the ROM 108 to the lamp driving circuit 126. Thus, decorative lamps 42a and 42b blinks and the like.

The display/input controller 140 is also connected to the input/output bus 104. The CPU 106 creates an image display command corresponding to the state and results of the game, and outputs the image display command thus created to the display/input controller 140 via the input/output bus 104. Upon reception of the image display command input from the CPU 106, the display/input controller 140 creates a driving signal for driving the liquid crystal display 30 according to the image display command thus input, and outputs the driving signal thus created to the liquid crystal display 30. As a result, a predetermined image is displayed on the liquid crystal display 30. The display/input controller 140 transmits the signal input through the touch panel 32 provided on the liquid crystal display 30 to the CPU 106 via the input/output bus 104 in the form of an input signal. In addition, the image display command includes commands corresponding to a payout display unit 48, a credit amount display unit 49, a bet amount display unit 50, and a stock credit amount display unit 51.

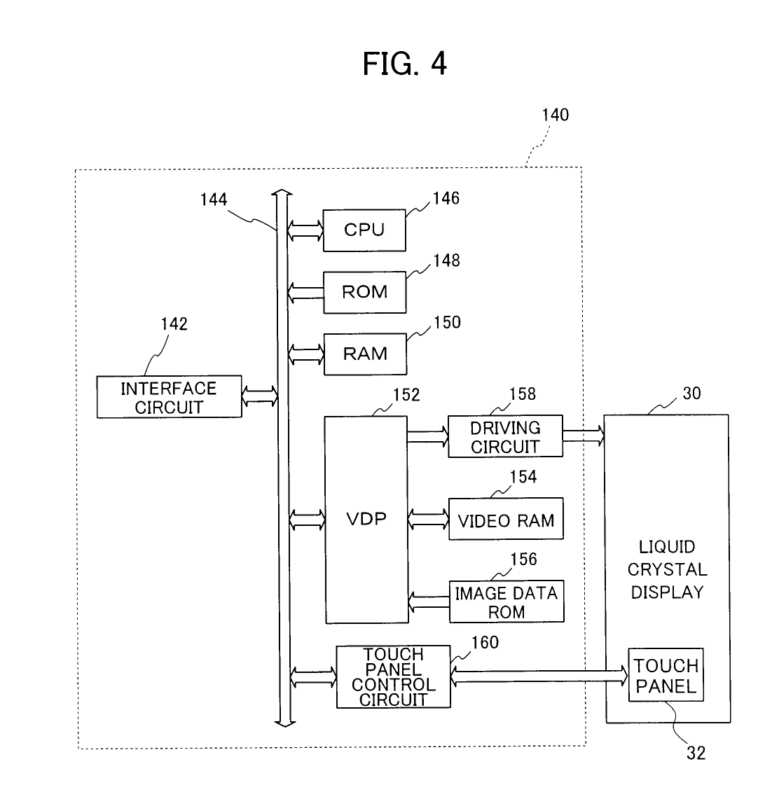

FIG. 4 is a block diagram which shows an electrical configuration of a display/input controller 140 of the gaming machine 13. The display/input controller 140 of the gaming machine 13 is a sub-microcomputer for performing image display processing and input control for the touch panel 32. The display/input controller 140 includes an interface circuit 142, an input/output bus 144, a CPU 146, ROM 148, RAM 150, a VDP 152, video RAM 154, image data ROM 156, a driving circuit 158, and a touch panel control circuit 160.

The interface circuit 142 is connected to the input/output bus 144. The image display command output from the CPU 106 of the game controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program for generating a driving signal, which is to be supplied to the liquid crystal display 30, according to an image display command received from the CPU 106 of the game controller 100. On the other hand, the RAM 150 stores flags and variables used in the display control program.

The VDP 152 is connected to the input/output bus 144. The VDP 152 includes a so-called sprite circuit, a screen circuit, a palette circuit, etc., and can perform various types of processing for displaying images on the liquid crystal display 30. With such an arrangement, the components connected to the VDP 152 include: the video RAM 154 for storing image data according to the image display command received from the CPU 106 of the game controller 100; and the image data ROM 156 for storing various types of image data including the aforementioned image data for visual effects etc. Furthermore, the driving circuit 158 for outputting a driving signal for driving the liquid crystal display 30 is connected to the VDP 152.

The CPU 146 instructs the video RAM 154 to store the image data which is to be displayed on the liquid crystal display 30 according to the image display command received from the CPU 106 of the game controller 100 by reading the display control program stored in the ROM 148 and by executing the program thus read. Examples of the image display commands include various types of image display commands including the image display commands for visual effects, etc.

The image data ROM 156 stores various types of image data including the image data for visual effects, etc.

The touch panel control circuit 160 transmits the signals input via the touch panel 32 provided on the liquid crystal display 30 to the CPU 106 via the input/output bus 144 in the form of an input signal.

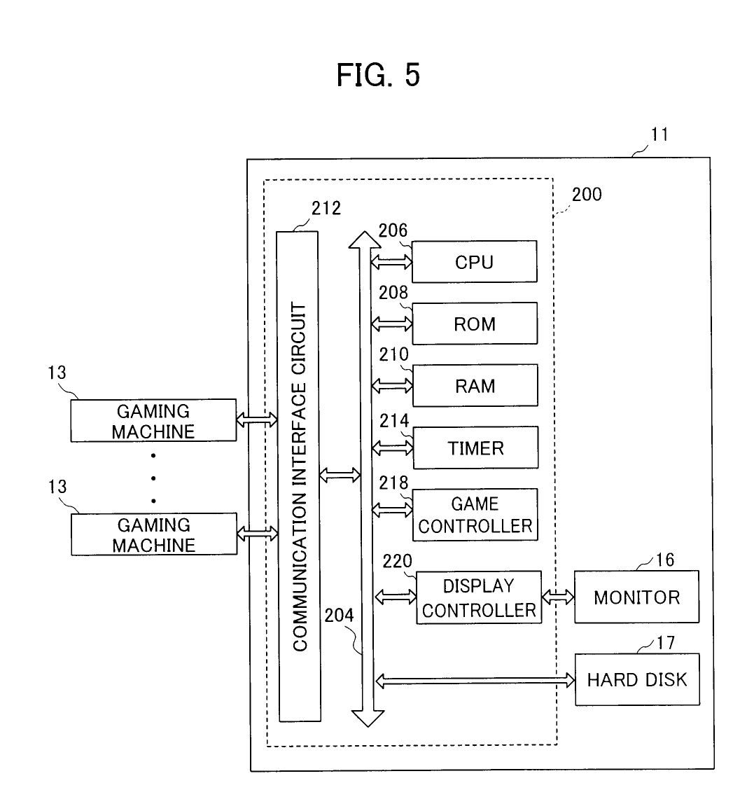

FIG. 5 is a block diagram which shows an electrical configuration of the controller 200 of the central controller 11. As shown in FIG. 5, the central controller 11 comprises the controller 200 of the central controller 11 and several peripheral devices. Furthermore, a plurality of gaming machines 13 is connected to the central controller 11 via the communication interface circuit 212 of the central controller.

Furthermore, the controller 200 of the central controller 11 includes an input/output bus 204, a CPU 206, ROM 208, RAM 210, a communication interface circuit 212, a timer 214, a game controller 218, and a display controller 220.

The ROM 208 and the RAM 210 are connected to the input/output bus 204.

The CPU 206 performs various types of processing according to an input signal supplied from each of the gaming machines 13, and data and programs stored the ROM 208 and the RAM 210. Furthermore, the CPU 206 transmits command signals to the gaming machines 13 based upon the results of the processing thus performed. Thus, the CPU 206 centrally controls each of the gaming machines 13, thereby advancing the game.

The ROM 208 comprises semiconductor memory or the like, for example. The ROM 208 stores a program for providing basic functions of the center controller 11 and a program for centrally controlling each of the slot machines 13.

On the other hand, the RAM 210 temporarily stores data regarding the results of the processing executed by the CPU 206, etc.

Furthermore, a game controller 218 is also connected to the input/output bus 204. CPU 206 receives a start signal transmitted via the communication interface circuit 212, and performs controlling a slot game cased on the data and programs stored in the ROM 208 and the RAM 210. Specifically, the CPU 206 controls displaying images that a video reel is being rotated and stopped, and also controls outputting sounds.

Furthermore, the display controller 220 is connected to the input/output bus 204. The CPU 206 performs various types of processing based upon the data and programs stored in the ROM 208 and the RAM 210. The CPU 206 controls the monitor 16 and captures images based upon the results of the processing thus performed.

A hard disk 17 is also connected to the input/output bus 204. The CPU 206 stores such as data of the amount of stock (described later) in the hard disk 17.

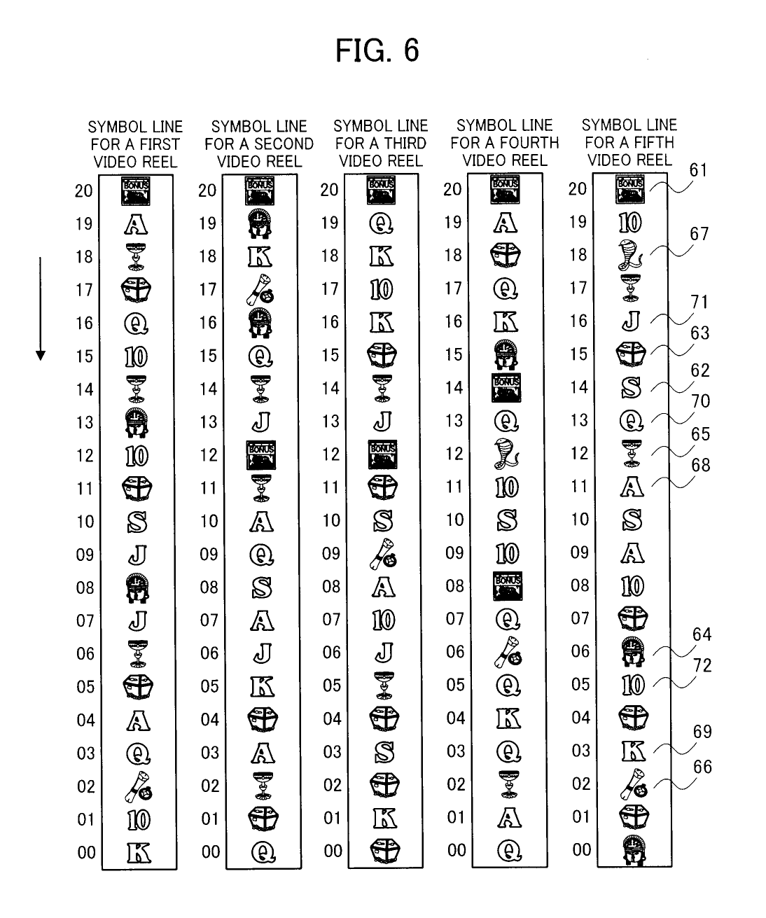

FIG. 6 shows symbol lines on which 21 symbols arranged on each video reel 3A to 3E are represented. The symbol line for the first video reel corresponds to the video reel 3A. The symbol line for the second video reel corresponds to the video reel 3B. The symbol line for the third video reel corresponds to the video reel 3C. The symbol line for the fourth video reel corresponds to the video reel 3D. The symbol line for the fifth video reel corresponds to the video reel 3E.

Referring to FIG. 6, code numbers of “00” to “20” are referred to for each symbol of video reels 3A to 3E. These code numbers are converted to data in a data table so as to be stored in the ROM 108 and the ROM 208.

On each video reel 3A to 3E, a symbol line is represented with symbols as follows: “Bonus” symbol (symbol 61) (hereafter, “Bonus”), “Wild” symbol (symbol 62) (hereafter, “Wild”), “Treasure Chest” symbol (symbol 63) (hereafter, “treasure chest”), “Golden Mask” symbol (symbol 64) (hereafter, “Golden Mask”)”, “Holy Grail” symbol (symbol 65) (hereafter, “Holy Grail”), “Compass and Map” symbol (symbol 66) (hereafter, “Compasses and Map”), “Snake” symbol (symbol 67) (hereafter, “Snake”), “Ace” symbol (symbol 68) (hereafter, “Ace”), “King” symbol (symbol 69) (hereafter, “King”), “Queen” symbol (symbol 70) (hereafter, “Queen”), “Jack” symbol (symbol 71) (hereafter, “Jack”), and “10” symbol (symbol 72) (hereafter, “10”). The symbol line of each video reel 3A to 3E displays an image moving in the direction of the arrow in FIG. 6 (moving below from the top) by displaying an image that the each video reel 3A to 3E is being rotated in a forward direction.

Here in the present embodiment, each combination of “Bonus”, “Wild”, “Treasure Chest”, “Golden Mask”, “Holy Grail”, “Compass and Map”, “Ace”, “King”, “Queen”, “Jack” and “10” is set as an award combination. A combination (combination data) is control information which relates credits provided to a player (the amount of payout of coins) to a combination of an award combination, and which is used for stop control of each video reel 3A through 3E, change (shift) of a game state, provision of coins, and the like.

In addition, a game which causes symbols to be achieved along an active pay line can be performed in the present embodiment.

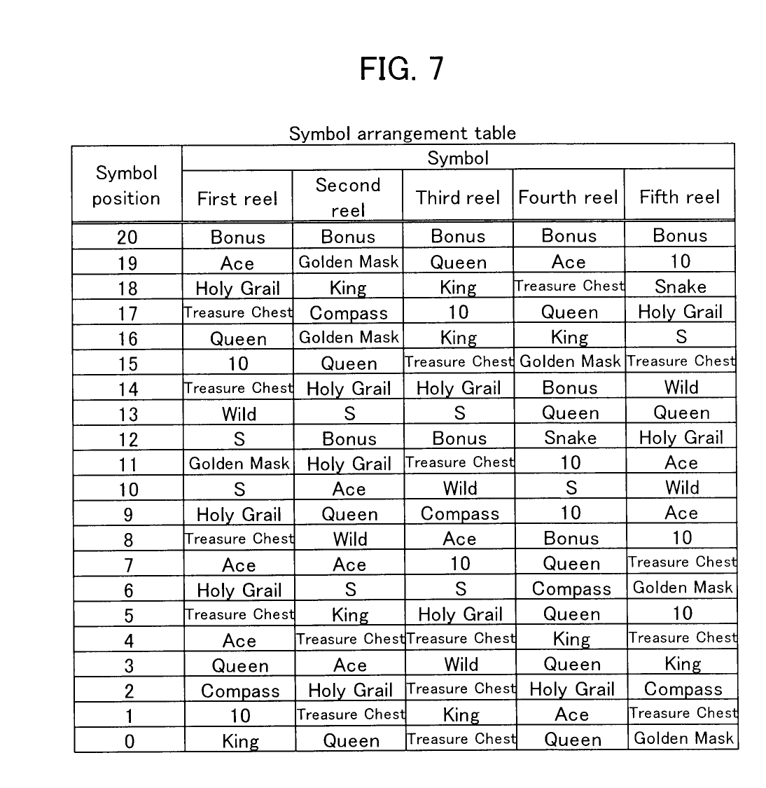

FIG. 7 shows a symbol arrangement table. The symbol arrangement table relates the code number indicating the position of each symbol which constitutes the symbol lines to each symbol of the respective video reels 3A to 3E, and then registers them. In addition, the first video reel through the fifth video reel corresponds to the video reels 3A to 3E, respectively. In other words, the symbol arrangement table includes symbol information corresponding to the symbol position (the code number) of video reels 3A to 3E.

FIG. 8 is a flowchart which shows a processing flow in a game of the gaming machine 13 executed by the game controller 100 of the gaming machine 13 according to the embodiment of the present invention. The one routine shown in FIG. 8 corresponds to one unit of the game.

Furthermore, let us say that the gaming machine 13 is started up beforehand. Furthermore, let us say that the variables used in the CPU 106 included in the game controller 100 have been initialized to predetermined values, thereby providing the normal operation of the gaming machine 13.

First, the CPU 106 included in the game controller 100 determines whether or not any credit remains, which corresponds to the remaining amount of coins inserted by the player (Step S1). More specifically, the CPU 106 reads a credit amount C stored in the RAM 110, and executes processing according to the credit amount C. When the credit amount C equals “0” (NO in Step S1), the CPU 106 terminates the routine without executing any processing, since it cannot start a game. When the credit amount C is not less than “1” (YES in Step S1), the CPU 106 determines that coins remain as credits, and the CPU 106 moves the processing to Step S2.

In Step S2, the CPU 106 determines whether or not a pushing operation has been executed on the spin bet repeat switch 24. When the switch 24 has been pushed and the CPU 106 receives a signal from the switch 24 (YES in Step S2), the CPU 106 moves the process to Step S13. On the other hand, when the CPU 106 does not receive the operation signal from the switch 24 after a predetermined period of time elapses (NO in Step S2), the CPU 106 determines that the switch 24 has not been pushed and moves the processing to Step S3.

In the following Step S3, the CPU 106 sets the game conditions. Specifically, the CPU 106 determines the amount of coins bet on the active pay lines in this game based on the operation of the bet switch 23. Then, the CPU 106 determines the bet amount to be bet on the active pay lines based upon the number of signals that indicate operation of the bet switch 23 have been received, and stores the bet amount thus determined in a predetermined memory area of the RAM 110. The CPU 106 reads the credit amount C stored in a predetermined memory area of the RAM 110, and subtracts the total bet amount, which is the sum of the bet amounts, from the credit amount C thus read. Then, the CPU 106 stores the subtracted value in a predetermined memory area of the RAM 110. Subsequently, the CPU 106 moves the processing to Step S4.

In the following Step S4, the CPU 106 determines whether the start switch 25 has been activated, and then waits for the start switch 35 to be operated. Upon the start switch 25 being operated, and accordingly, upon the operation signal being input from the start switch 25 (in a case of “YES” in the determination processing in Step S4), the CPU 106 determines that the start switch 25 has been operated, and the flow proceeds to Step S5.

On the other hand, in Step S13, the CPU 106 determines whether or not the amount of credits C is equal to or greater than the total bet number in a previous game. In other words, the CPU 106 determines whether or not it can start a game in response to a pushing operation executed on the spin repeat bet switch 24. Specifically, in a case that the spin repeat bet switch 24 has been pushed, and accordingly, in a case that the operation signal has been input from the switch 24, the CPU 106 reads the credit amount C and the bet amount bet on each of the active pay lines L1 to L9 in the previous game stored in the predetermined memory areas of the RAM 110. Then, the CPU 106 determines whether or not the aforementioned credit amount C is equal to or greater than the total bet amount bet in the previous game based upon the relation between the credit amount C and the bet amount thus read. When the CPU 106 determines that the amount of credits C is less than the total bet number (NO in Step S13), the CPU 106 terminates the routine without any process, because it cannot start a game. On the other hand, in a case where determination has been made that the amount of credit C is at least the total bet amount bet in the previous game (in a case of “YES” in the determination processing in Step S13), the CPU 106 subtracts the total bet amount bet in the previous game from the amount of credits C, and stores the subtracted value in a predetermined area of the RAM 110. Subsequently, the CPU 106 moves the processing to Step S5.

In the following Step S5, the CPU 106 performs combination determination processing. Specific description is made below regarding the combination determination processing.

In the aforementioned combination determination processing, first, the CPU 106 determines the combinations of the stationary symbols along the aforementioned active pay lines. Specifically, the CPU 106 issues a command for the random number generator 112 to generate a random number, thereby extracting a random number in a predetermined range (in a range of “0” to “65535” in the present embodiment) generated by the random number generator 112. The CPU 106 stores the random number thus extracted in a predetermined memory area of the RAM 110. It should be noted that a description is provided in the present embodiment regarding an arrangement in which the random number is generated by the random number generator 112, which is a separate component from the CPU 106. In addition, an arrangement may be made in which the random number is generated by computation processing by the CPU 106 without involving the random number generator 112. Specifically, a random number is generated by computation processing by the CPU 106 when the central controller executes. The CPU 106 reads a random number table, and a specified combination table for providing an award, each of which is stored in the ROM 108. Then, the CPU 106 stores the random number table and the specified combination table thus read in a predetermined memory area of the RAM 110. Note that the CPU 106 controls display of the stationary symbols for each reel based upon the aforementioned random number table. Furthermore, the CPU 106 reads the random number table and the specified combination table for providing an award stored in the predetermined area of the RAM 110. Then, the CPU 106 determines the combination of the stationary symbols with respect to the aforementioned active pay lines with reference to the aforementioned random number table as a parameter, using the random number stored in the predetermined memory region of the RAM 110. Upon determination of specified combinations for providing an award, the CPU 106 stores the specified combination data for providing an award thus determined in a predetermined memory area of the RAM 110. Then, the CPU 106 reads the random number and the specified combination data for providing an award stored in the predetermined memory area of the RAM 110, and determines the combination of the symbols displayed to be stationary based upon the random number and the specified combination data for providing an award thus read. In this stage, a symbol arrangement table stored in the ROM 108 is read by the CPU 106. The symbol arrangement table thus read is stored in a predetermined memory area of the RAM 110, and used as reference data. The CPU 106 stores the data for the stationary symbols thus determined in a predetermined memory area of the RAM 110. Alternatively, an arrangement may be made in which the stationary symbols are determined for each reel using the aforementioned random number table.

Upon determination of the combination of the stationary symbols with respect to the active pay lines, the CPU 106 determines whether the combination of the stationary symbols with respect to the active pay lines matches any one of the specified combinations for providing an award. In a case where the combination of the stationary symbols with respect to the active pay lines matches any one of the specified combinations for providing an award, the CPU 106 activates a flag, which indicates that the player has won the award that corresponds to the kind of specified combination for providing an award, in order to provide the award that corresponds with the specified combination of symbols with respect to the active pay lines for providing the award. The activated flag, which indicates the player has won an award, is stored in a predetermined area of the RAM 110 according to the instruction from the CPU 106. On the other hand, in a case where the combination of the stationary symbols with respect to the active pay lines matches any one of the other combinations, i.e. the losing combinations, the CPU 106 does not activate the flag which indicates that the player has won an award. Subsequently, the CPU 106 moves the process to Step S6.

In the following Step S6, the CPU 106 instructs the video reels 3A through 3E to start to rotate. Specifically, the CPU 106 displays an image which shows the video reels 3A to 3E rotating, in sequence or simultaneously, based upon the symbol arrangement table stored in the RAM 110.

Upon displaying the image which shows the video reels 3A to 3E starting to rotate, the CPU 106 waits for a predetermined period of time to elapse (Step S7). After the predetermined period of time has elapsed (in a case of “YES” in the determination processing in Step S7), the CPU 106 instructs the video reels 3A to 3E to automatically stop rotating (Step S8). Specifically, the CPU 106 displays an image which shows the video reels 3A to 3E stopping rotation in sequentially or simultaneously such that the stationary symbols, which correspond to the specified combinations for providing an award determined in the Step S5, are displayed within a display region that has a visually interactive relationship with the player. Subsequently, the CPU 106 moves the process to Step S9.

In the following Step S9, the CPU 106 determines whether or not a predetermined symbol combination has been formed based upon the results of the combination determination processing performed in Step S5. Specifically, the CPU 106 makes this determination based upon the state of the flag that indicates whether the player has won an award with respect to the active pay lines stored in the predetermined memory area of the RAM 110. In a case that the flag, which indicates that the player has won an award, has not been activated, i.e., in a case that the symbol combination matches any one of the “other” combinations, which are combinations other than the specified combinations for providing an award (in a case of “NO” in the determination processing in Step S9), the CPU 106 determines that the specified combination for providing an award has not been formed, and ends this routine. On the other hand, in a case that the flag, which indicates that the player has won an award, has been activated, i.e., in a case that the symbol combination matches any one of the combinations other than the “other” combinations (in a case of “YES” in the determination processing in Step S9), the flow proceeds to Step 10 according to the instruction from the CPU 106.

In a case where the flow has proceeded to Step S10, the CPU 106 pays out the amount of coins corresponding to the aforementioned specified combination for providing an award. Specifically, the CPU 106 calculates the number of coins to be paid out that corresponds to the specified symbol combination that provides the award with reference to the payout table. The CPU 106 reads the credit amount stored in the predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the sum thus stored on the credit amount display unit 49. Subsequently, the flow proceeds to Step S11 according to the instruction from the CPU 106.

In the following Step S11, the CPU 106 determines whether the symbol combination thus formed based upon processing for determining a combination performed in Step S5 is a “Bonus”. Specifically, in a case that the specified combination is “Bonus” which provides an award (in a case of “YES” in the determination processing in Step S11), the CPU 106 advances the flow to Step S12. On the other hand, in a case that the specified combination is not “Bonus” which provides an award (in the case of determination of “NO” in the processing in Step S11), the CPU 106 ends the routine.

In the following Step S12, the CPU 106 performs paying out a bonus. Subsequently, the CPU 106 terminates the routine.

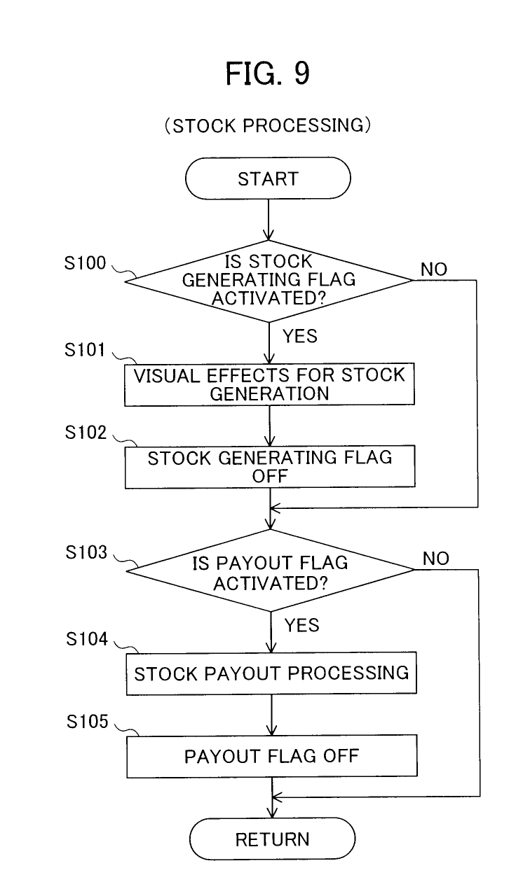

Next, stock processing, stock generation processing, and stock payout processing, which the gaming machine 13 executes, are described based on FIGS. 9 to 13. The stock processing is started when rotation of a reel is stopped (Step S9) in FIG. 8.

The CPU 106 determines whether a stock generating flag is activated or not (Step S100). The stock generating flag is activated by stock generation processings 1 to 3, which are described later. In a case where the stock generating flag is activated, the CPU 106 performs visual effects for a stock generation by the liquid crystal display 30, the speaker 41, and the like (Step S101). The CPU 106 turns the stock generating flag off after performing the visual effects for a stock generation (Step S102). In a case where the stock generating flag is not activated, the CPU 106 moves the processing to Step S103.

Regarding the visual effects for a stock generation, the amount of stock accumulation, which is the amount of credits accumulated by a stock generation, may be displayed on the liquid crystal display 30 so as to inform a player. Alternatively, sound data corresponding to the amount of stock accumulation may be output using the speaker 41. In other words, sound data with a low tone may be output in a case where the amount of stock accumulation is a great amount. In a case where the amount of stock accumulation is a small amount, sound data with a high tone may be output. For example, in a case where sound data with different tones is output without displaying the amount of stock accumulation on the liquid crystal display 30, a player can infer the amount of stock accumulation based on the sound data output. Sound data for stock sound data may be that which is similar to the sound that a coin is accumulated, such as “ching”. Furthermore, the sound “ching” with a low tone may be output corresponding to the amount of stock accumulation. Such sound data is stored in the RAM 110.

In addition, although the CPU 106 turns the stock generating flag off at this point, the CPU may determine the display status of a stationary symbol based on the flag without turning it off. In other words, when the stock generating flag is activated, the CPU 106 may display a combination in which symbols “S” indicating that a stock has been generated are stopped on a line L5 as shown in FIG. 20. Therefore, in the combination determination processing in Step S5, the CPU 106 ensures the status of the stock generating flag (ON/OFF), and then may turn a payout flag off after determining to stop the symbols “S” on the line L5.

In the following Step S103, the CPU 106 determines whether the payout flag is activated or not. The payout flag is activated by stock payout processing described later. In a case where the stock payout flag is activated, the CPU 106 performs stock payout processing (Step S104). The stock payout processing pays out the amount of payout determined in Step S33 to a player, and also subtracts the amount of credits paid out (the amount of payout) from the amount of stocks. Then, the CPU 106 turns the flag off and terminates the processing (Step S105). It should be noted that the amount of payout as described above refers to the partial amount of credits which is paid out this time. In Step S103, in a case where the stock payout flag is off, the CPU 106 terminates the processing. When the abovementioned processings ends, the CPU 106 moves the processing to slot game processing in Step S9.

When performing the stock payout processing, an image and sound for visual effects indicating the payout processing may be output by employing the liquid crystal display 30 and the speaker 41.

In addition, although the CPU 106 turns the stock payout flag off at this point, the CPU may determine the display status of a stationary symbol based on the flag without turning it off. In other words, when the stock payout flag is activated, the CPU 106 may display a combination in which symbols “S” indicating that a stock is paid out are stopped on a line L5 as shown in FIG. 21 (Although the symbol “S” indicating that a stock is paid out is described as the same as “S” indicating that a stock is generated, a symbol indicating that a stock is paid out may be different from a symbol indicating that a stock is generated). Therefore, in the combination determination processing in Step S5, the CPU 106 ensures the status of the stock generating flag (ON/OFF), and then may turn a payout flag off after determining to stop the symbols “S” on the line L5.

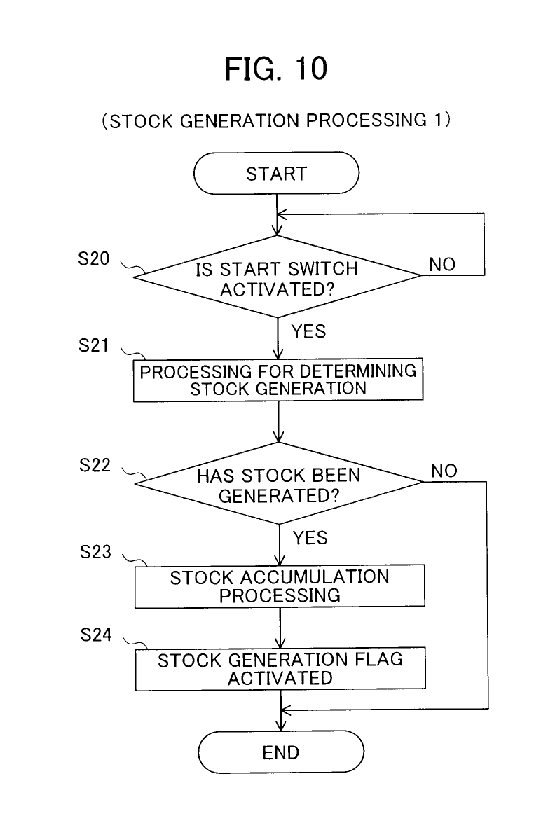

FIG. 10 is a flowchart showing a flow of stock generation processing 1 that the CPU 106 performs. The stock generation processing 1 is started by receiving a signal that the start switch has been activated (Step S20). The CPU 106 performs processing for determining stock generation (Step S21). In processing for determining stock generation, the CPU 106 determines the amount of stock accumulation based on a random number randomly extracted on a second random number table. The CPU 106 determines that a stock is generated if the amount of stock accumulation is other than zero (Step S22). In a case where a stock is not generated, the CPU 106 terminates the processing. In a case where a stock is generated, the CPU 106 adds the amount of stock accumulation to the current amount of stock, and performs stock accumulation processing in which the amount of stock thus added in RAM 110 is stored as the renewed amount of stocks (Step S23). The amount of stock may be stored in the RAM 110 or a hard disk 17, which actualizes a credit retaining memory.

Next, the CPU 106 activates the stock generating flag, and terminates the processing (Step S24). Upon terminating the processing, the CPU 106 moves the slot game processing to Step S5.

The amount of stock refers to the amount of credits that a stock generated and accumulated so as to be pooled. In other words, the amount of stock accumulated (the amount of stock accumulation) is determined by single stock generation, and thus the amount of stock accumulation cumulatively added is equal to the amount of stock. The amount of stock thus stocked is paid out at a predetermined amount in stock payout processing described later.

The amount of stock is employed as a bet in order to perform a game and is set as the amount of credits which is separated from the amount of credits which can be constantly converted to coins and the like. The CPU 106 performs determining to allow the amount of stock to be accumulated, determining to pay out the amount of stock, and the like, which are substantially distinct from determining to achieve a bonus combination, for example. In addition, regarding the amount of stock, an initial value may not be zero at the time of starting a game. The amount of stock at the time of starting a game may be, for example, 200 as a predetermined value. For example, upon supplying power, the RAM 110 is configured to store a value 200 as an initial value for the amount of stock stored beforehand in the hard disk. The initial value 200 may be set appropriately, such as 50, 300, etc., as long as the value is high enough to be paid out as a credit retaining memory which is an initial resource in a first game upon supplying power.

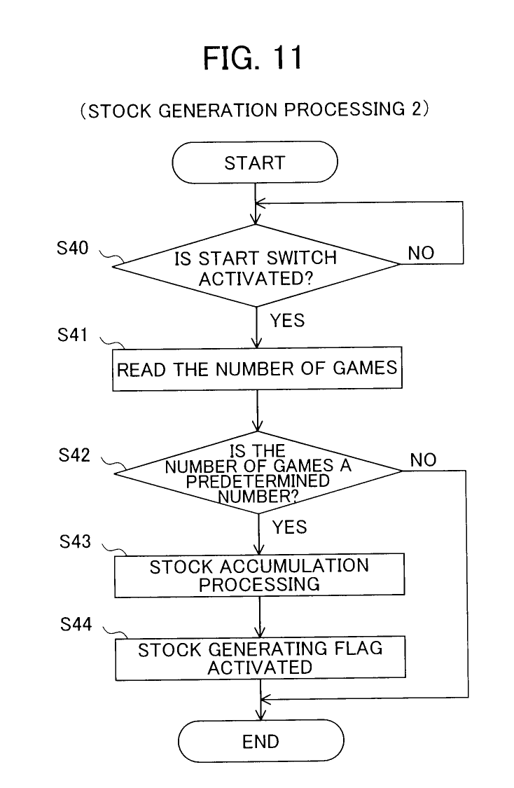

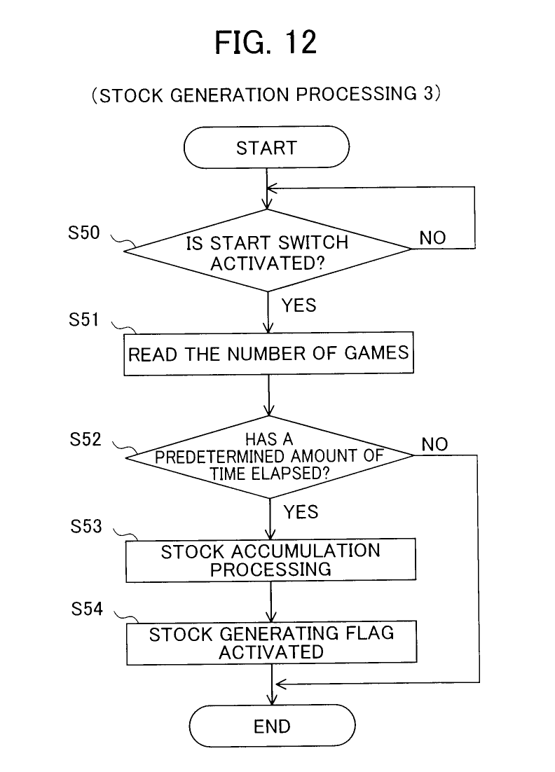

FIGS. 11 and 12 is a flowchart showing stock generation processings 2 and 3 which the CPU 106 performs. Similar to the stock generation processing 1, the stock generation processings 2 and 3 are started when a start switch is activated. The stock generation processings 2 and 3 performs the same processing as the stock generation processing 1 except for Steps S41, S42, S51, and S52.

Regarding the stock generation processing 2, the number of games in which slot game processing in FIG. 8 has been executed is stored in the RAM 110. In other words, the number of games refers to the number of routines executed. In a single routine (a unit game), Step S1 through Step S12 in FIG. 8 are executed. In addition, a predetermined number of games is stored in the RAM 110. Based on the predetermined number of games, stock accumulation is generated by executing a predetermined number of games. Thus, it is possible to accumulate a stock routinely corresponding to the number of games.

The CPU 106 determines whether the current number of games falls into the predetermined number of games which is determined beforehand (Step S42). In a case where the number of games falls into the predetermined number of games, the CPU 106 performs stock accumulation processing (Steps S42 and S43). In a case where the number of games does not fall into the predetermined number of games, the CPU 106 terminates the processing.

Regarding the stock generation processing 3, the CPU 106 measures a predetermined time. In other words, the CPU 106 may measure an elapsed time since activating the gaming machine 13, an elapsed time since a bonus occured previously, an elapsed time since the start switch 25 has not been activated, and the like. In a case where the elapsed time thus measured falls into a predetermined time, stock accumulation may be generated.

The CPU 106 determines whether or not the current elapsed time falls into a predetermined elapsed time which is determined beforehand (Step S52). Then, in a case where the current elapsed time falls into a predetermined elapsed time which is determined beforehand, the CPU 106 performs stock accumulation processing (Steps S52 and S53). In a case where the current elapsed time does not fall into a predetermined elapsed time which is determined beforehand, the CPU 106 terminates the processing.

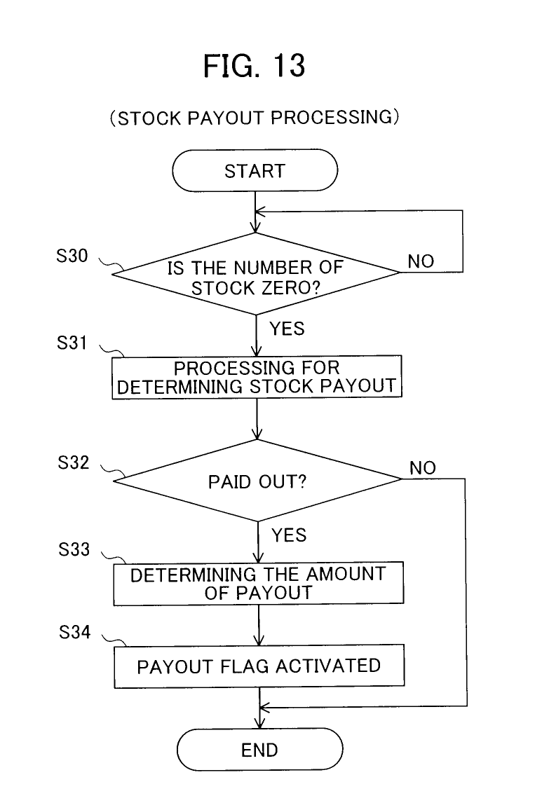

FIG. 13 is a flowchart which shows stock payout processing which the CPU 106 performs. The stock payout processing is started by receiving a signal that a start switch 25 has been activated. The CPU 106 determines whether the amount of stock is zero or not (Step S30). In a case where the amount of stock is zero, the CPU 106 does not start to perform payout processing since it cannot be paid out. In a case where the amount of stock is not zero, the CPU 106 performs stock payout processing. In other words, the CPU 106 determines whether to perform payout based on the number determined by random numbers on a fourth random number table (a). Then, in a case of determining to perform payout (Step S32), the CPU 106 determines the amount of payout based on the number determined by random numbers on the fourth random number (b) (Step S33). Then, the CPU 106 activates the payout flag (Step S34) and terminates the processing. When the CPU 106 terminates this processing, the CPU moves the slot game processing to Step S5.

In addition, payout may be performed to be divided by a plurality of games. In other words, with a unit game as a single game, the payout may be divided by a plurality of games and a single payout processing determined may be performed. More specifically, in a case where 100 credits are paid out, 50 credits are paid out in a unit game which is determined to be paid out from credit retaining memory. Then, during five sequential games, 10 credits may be paid out in increments of games, or a predetermined amount of credits may be paid out at a random timing in the sequential games without paying out the credits in a unit game which is determined to be paid out from credit retaining memory. In the latter case, if the end of payout remains to be unknown to a player, it can allow the player to continue the slot game.

FIG. 14 shows a first random number table which is referred to in the slot game described in FIG. 8. In the first random number table, a range of random numbers and the probability of winning are registered in association with each of the specified winning combinations. With such an arrangement, a random number is extracted in a range of “0” to “65535”. Accordingly, in the combination determination processing (Step S5 in FIG. 8), in a case where a random number has been extracted in a range of “0” to “29”, for example, determination is made in the gaming machine 13 that a specified winning combination that provides a “BONUS” award is to be provided as the final result of the game. In other words, the probability is “30/65536” that the combination of the stationary symbols matches a specified combination for providing the “BONUS” award. Furthermore, in a case where a random number falling in a range of “3000” to “3999” is extracted from a range of numbers “0” to “65535”, for example, the internal component of the gaming machine 13 determines to generate a specified combination for providing a “K” award as the final result of the game. In other words, the probability is “1000/65536” that the combination of the stationary symbols matches a specified combination for providing the “K” award. On the other hand, in a case where a random number lying in a range of “10000” to “65535” is extracted from a range of numbers “0” to “65535”, the internal component of the slot machine 13 determines to generate other combinations, i.e. losing combinations, as the final results of the game. In other words, the probability is “55536/65536” that the combination of the stationary symbols matches any one of the losing combinations.

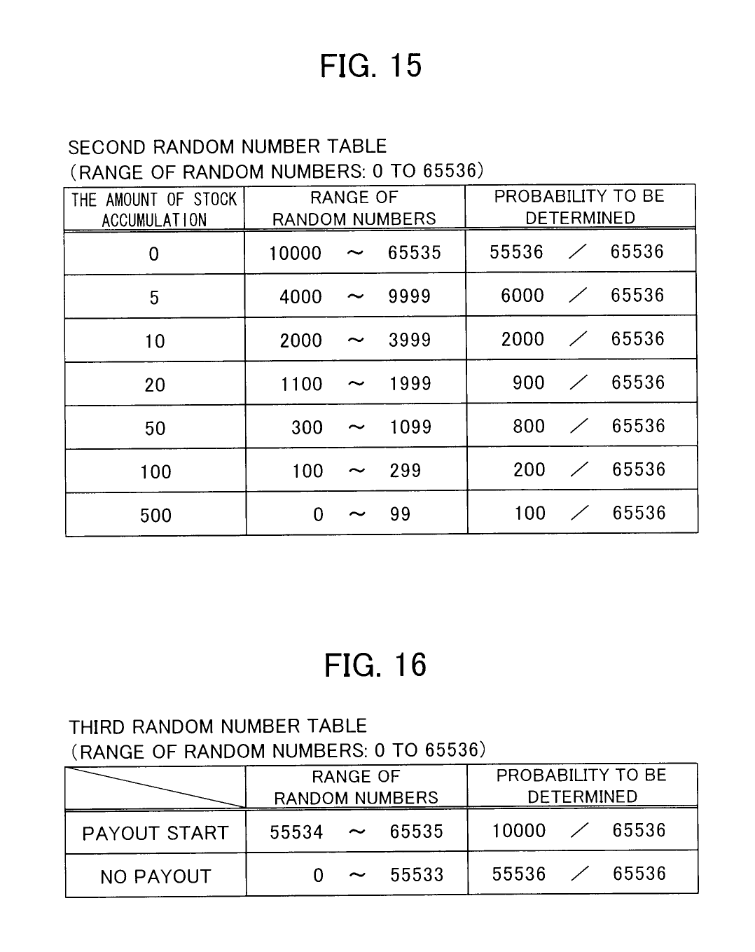

FIG. 15 shows a second random number table which is referred to in stock generation processing. The amount of stock accumulation is determined corresponding to a random number value that the CPU 106 generates.

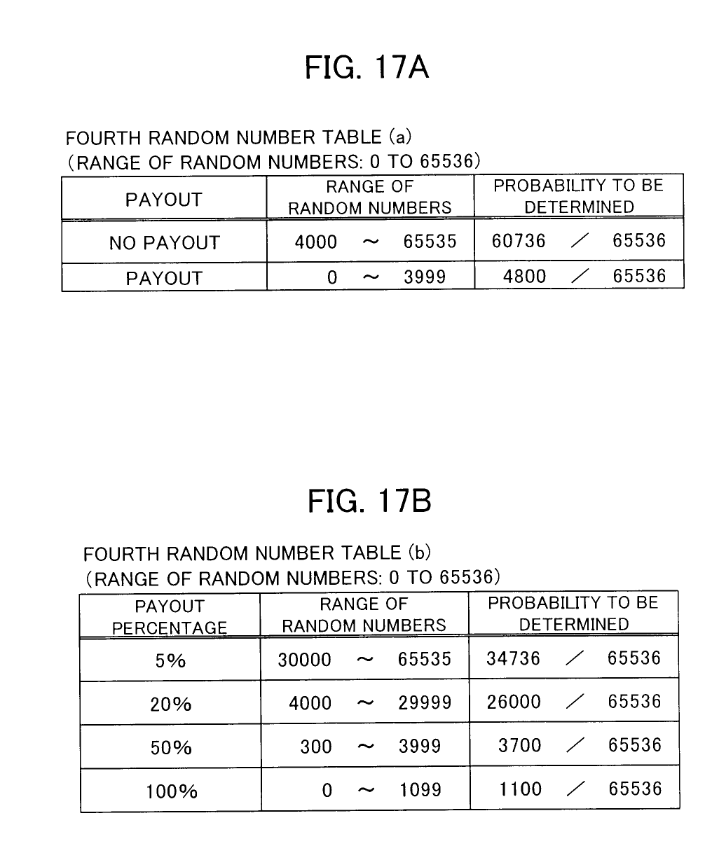

FIG. 16 shows a third random number table which is referred to in stock payout processing. Whether credits are paid out or not is determined corresponding to a random number value that the CPU 106 generates.

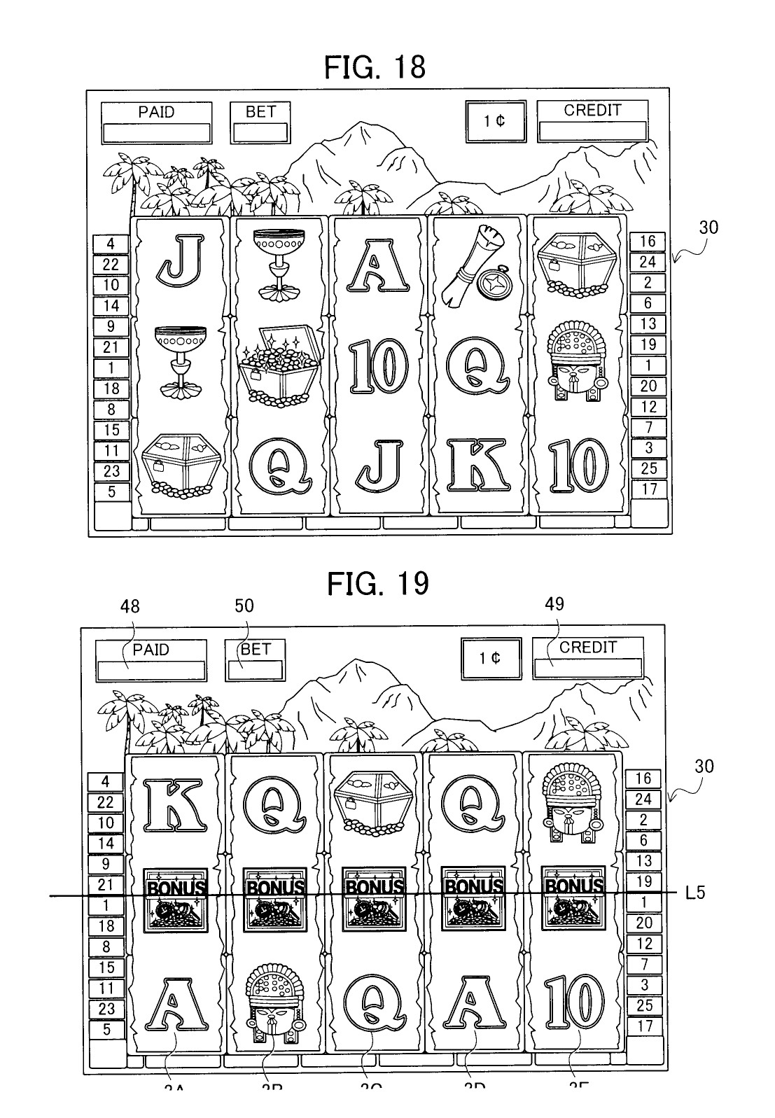

FIGS. 17A and 17B show a fourth random number table which is referred to in stock payout processing. Based on whether credits are paid out or not and a total amount of the amount of stock (a total amount of credits stored in a credit retaining memory), the amount that is paid out is determined corresponding to a random number value that the CPU 106 generates. For example, in a case where the amount of stock is 5000 and the percentage of payout is determined to be 20%, the amount of payout is determined to be 1000. It should be noted that a predetermined amount, instead of a percentage, may be employed on the determination of the amount of payout. In other words, the absolute amount of payout, such as 10 credits, 100 credits, and the like may be employed. In this case, a list of percentage on the fourth random number table is a list of the predetermined amount of payout.

In addition, in these random number tables, although the CPU 106 determines a random number value respectively for each table and refers to each random number table, the random number values determined by the CPU 106 may be employed in other random number tables.

FIGS. 18 to 21 are diagrams showing examples of games in the gaming machine 13 according to the embodiment of the present invention. In the example shown in FIG. 18, although the stationary symbols are displayed on the liquid crystal display 30 of the gaming machine 13, a predetermined combination is not achieved. On the other hand, in the example shown in FIG. 19, symbols of “BONUS” are stopped on the active pay line L5. More specifically, in FIG. 19, a payout display unit 48, a bet amount display unit 50, and a credit amount display unit 49 are configured to be displayed, on the upper side of the liquid crystal display 30, in order from the left. Furthermore, in the center of the image, five video reels 3A to 3E are displayed when they are stationary. When a combination except “Other” shown in FIG. 14 on the line shown in the FIG. 4 is achieved, a predetermined credit is paid out. In this example, the predetermined amount of credits shown by “Bonus” is paid out. In FIGS. 18 and 19, since the amount of stock is not displayed on the liquid crystal display 30, the player cannot recognize the amount of stock. However, as described above, since the CPU 106 performs stock generation processing and activates the stock generating flag so as to display the amount of stock accumulation and output sound, the player can enjoy a game remembering the display and the output, which allows the player to estimate the amount of stock.

FIG. 20 is an example illustrating symbols “S” indicating that a stock is generated as a combination on the liquid crystal display 30 and an example which displays the amount of stock on the stock credit amount display unit 51. As described above, in FIG. 9 (S102), the CPU 106 determines a display status of a stationary symbol based on the stock generating flag without turning it off. In this case, when the stock generating flag is activated, the CPU 106 may display a combination in which symbols “S” indicating that a stock payout has been generated are stopped on a line L5.

In addition, FIG. 20 displays the amount of stock on the liquid crystal display 30. Therefore, the player can visually recognize the current amount of stock constantly.

FIG. 21 is an example which shows displaying symbols “S” indicating that a stock payout is generated as a combination on the liquid crystal display 30. As described above, in FIG. 9 (S105), the CPU 106 determines a display status of a stationary symbol based on the payout flag without turning it off. In other words, when the stock generating flag is activated, the CPU 106 may display a combination in which symbols “S” indicating that a stock payout has been generated are stopped on a line L5. Although the symbol “S” indicating that a stock is paid out is described as the same as “S” indicating that a stock is generated, a symbol indicating that a stock is paid out may be different from a symbol indicating that a stock is generated.

In addition, FIG. 21 shows an example displaying notice image data 80 on the liquid crystal display 30 indicating the amount of payout (determined in Step S33) which is paid out from a stock. Thus, the CPU 106 may display the notice payout image 80 indicating the amount of payout. The notice image data 80 is stored beforehand in the RAM 110 corresponding to the amount of payout.

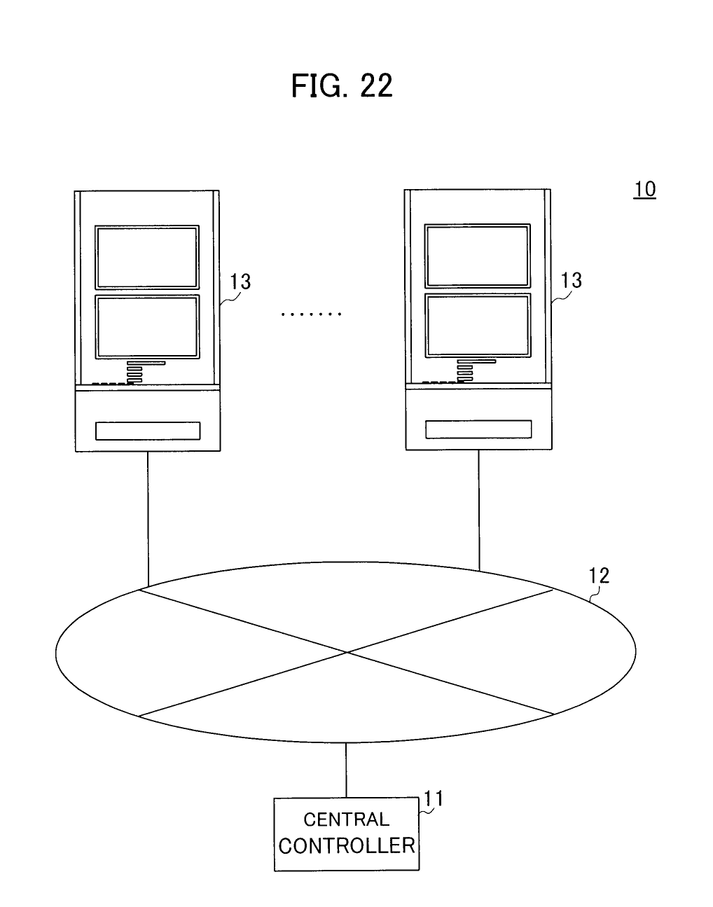

FIG. 22 is a block diagram showing a configuration of a gaming system 1. In the gaming system 1 shown in FIG. 1, a network 12 is connected with a plurality of gaming machines 13 and a central controller 11. The central controller 11 includes the configuration described in FIG. 5. The central controller 11 receives data related to the amount of stock received from the gaming machine 13 so as to store the data in the hard disk 17. Therefore, it is possible to control remotely the amount of stock for each gaming machine 13.

It should be noted that the advantages described in association with the embodiments of the present invention are merely a listing of advantages of the present invention, and that the advantages of the present invention are by no means restricted to those described in connection with the embodiments of the present invention. While the embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims. For example, the present invention can be widely applied to a card game, a table game such as mahjong game, and the like, as well as a slot machine game as a gaming machine. It is apparent to one skilled in the art that the various changes and modifications may be included in the technical scope of the appended claims.

1. A gaming machine, comprising:
a game controller for providing a predetermined amount of credits to a player for each award in a case where a game is started after the player inputs a bet and a game result which provides an award to the player occurs; and
a display device for displaying the game result to the player,
wherein the game controller is configured to perform the operations of:
(a) determining whether to store a predetermined amount of credits in credit retaining memory disposed either inside or outside the game controller in a unit game where processing for determining whether to provide the award to the player is performed, and, in a case of determining to store the predetermined amount of credits, storing the amount of credits which is the amount of credits thus determined added to the amount of credits stored in the credit retaining memory;
(b) determining whether or not to provide a portion of a total amount of credits stored in the credit retaining memory to the player in a unit game where processing for determining whether to provide the award to the player is performed; and
(c) in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

2. A gaming machine according to claim 1,
wherein the determination in processing (a) is determined based on a numeric value determined by random numbers.

3. A gaming machine according to claim 1,
wherein a portion of the amount of credits among a total amount of credits provided to the player is determined based on a numeric value determined by random numbers in processing (c).

4. A gaming machine according to claim 1,
wherein sound data corresponding to the amount of credits provided to the player is output when the portion of the total amount of credits is provided to the player in processing (c).

5. A gaming machine according to claim 1,
wherein determining whether to store the amount of credits to which the amount of credits stored in the credit retaining memory is cumulatively added is based on the number of games executed.

6. A gaming machine according to claim 1,
wherein determining whether to store the amount of credits to which the amount of credits stored in the credit retaining memory is cumulatively added is based on whether a predetermined amount of time has elapsed.

7. A gaming machine according to claim 1,
wherein, in a case of determining whether to provide a portion of the total amount of credits to the player, image data corresponding to the amount of credits provided to the player is output when the portion of the total amount of credits is provided to the player.

8. A gaming machine according to claim 1,
wherein a game which the gaming controller executes is a slot machine game, and wherein the unit game refers to a game with one unit during which the player bets a credit, so that a reel is rotated and then stopped.

9. A gaming machine, comprising:
a game controller for providing a predetermined amount of credits to a player for each award in a case where a game is started after the player inputs a bet and a game result which provides an award to the player occurs; and
a display device for displaying the game result to the player,
wherein the game controller is configured to perform the operations of:
(a) determining whether to store a predetermined amount of credits, which is different from the credit that the player input as the bet, in credit retaining memory installed inside or outside the game controller in a unit game where processing for determining whether to provide the award to the player is performed, and, in a case of determining to store the predetermined amount of credits, storing the amount of credits which is the amount of credits thus determined cumulatively added to the amount of credits stored in the credit retaining memory;
(b) determining whether to provide a portion of a total amount of credits stored in the credit retaining memory to the player in a unit game where processing for determining whether to provide the award to the player is performed; and
(c) in a case of determining to provide a portion of the total amount of credits stored in the credit retaining memory to the player, providing a portion of the total amount of credits stored in the credit retaining memory to the player and subtracting the amount of credits thus provided to the player from the amount of the total amount of credits stored in the credit retaining memory.

10. A method of playing a game, comprising processing for:
(a) starting a game after a player inputs a bet;
(b) providing a predetermined amount of credits for each award to the player in a case where a game result which provides an award to the player occurs;
(c) displaying a game result to the player;
(d) determining whether to store a predetermined amount of credits in a memory in a unit game where processing for determining whether to provide the award to the player is performed, and, in a case of determining to store the predetermined amount of credits, storing the amount of credits which is the amount of credits thus determined cumulatively added to the amount of credits stored in the memory;
(e) determining whether to provide a portion of the total amount of credits stored in the memory to the player in a unit game where processing for determining whether to provide the award to the player is performed; and
(f) in a case of determining to provide a portion of the total amount of credits stored in the memory to the player, providing a portion of the total amount of credits stored in the credit retaining memory to the player and subtracting the amount of credits thus provided to the player from the amount of the total amount of credits stored in the memory.

11. A method of playing a game according to claim 10,
wherein the determination in processing (a) is determined based on a numeric value determined by random numbers.

12. A method of playing a game according to claim 10,
wherein a portion of the amount of credits among the total amount of credits provided to the player is determined based on a numeric value determined by random numbers in processing (c).

13. A method of playing a game according to claim 10,
wherein sound data corresponding to the amount of credits provided to the player is output when the portion of the total amount of credits is provided to the player in processing (c).

14. A method of playing a game according to claim 10,
wherein determining whether to store the amount of credits to which the amount of credits stored in the memory is cumulatively added is based on the number of games executed.

15. A method of playing a game according to claim 10,
wherein determining whether to store the amount of credits to which the amount of credits stored in the memory is cumulatively added is based on whether a predetermined amount of time has elapsed.

16. A method of playing a game according to claim 10,
wherein, in a case of determining whether to provide a portion of the total amount of credits to the player, an image corresponding to the amount of credits provided to the player is output when the portion of the total amount of credits is provided to the player.
